(19) United States
(12) Patent Application Publication
(10) Pub. No.: US 2023/0155200 A1
(43) Pub. Date: May 18, 2023

(54) MODULE MONITOR UNIT FOR AN ELECTRIC AIRCRAFT BATTERY PACK AND METHODS OF USE

(71) Applicant: BETA AIR, LLC, South Burlington, VT (US)

(72) Inventors: Braedon Lohe, Essex Junction, VT (US); Cullen Jemison, Winooski, VT (US); Andrew Giroux, Georgia, VT (US); Tom Hughes, SOUTH BURLINGTON, VT (US)

(73) Assignee: BETA AIR, LLC, SOUTH BURLINGTON, VT (US)

(21) Appl. No.: 17/529,447

(22) Filed: Nov. 18, 2021

(51) Int. Cl. H01M 10/48; H01M 10/42

(52) U.S. Cl. CPC H01M 10/486; H01M 10/425; H01M 10/482; H01M 2010/4271; H01M 2220/20

(57) ABSTRACT

A module monitor module (MMU) is configured to assist in integrated battery management of an electric aircraft battery pack. An MMU is configured to detect a temperature of a battery cell of an electric aircraft battery pack to determine if the battery cell is malfunctioning. If the battery cell of the battery pack is determined to be malfunctioning, then the power supply to the malfunctioning battery cell is terminated until the battery cell has been fixed and/or the temperature no longer exceeds a predetermined threshold associated with the temperature of the battery cell.

### FIELD OF THE INVENTION

The present invention generally relates to the field of electric aircrafts. In particular, the present invention is directed to a module monitor unit for an electric aircraft battery pack and methods of use.

### BACKGROUND

The burgeoning of electric vertical take-off and landing (eVTOL) aircraft technologies promises an unprecedented forward leap in energy efficiency, cost savings, and the potential of future autonomous and unmanned aircraft. However, the technology of eVTOL aircraft is still lacking in crucial areas of energy source solutions.

### SUMMARY OF THE DISCLOSURE

In an aspect, a monitor module unit (MMU) for an electric aircraft battery module including: a housing attached to a battery module of an electric aircraft; a control circuit at least partially disposed within the housing, the control circuit configured to: receive a measurement datum of a battery module from a communicatively connected sensor; determine an operating condition of the battery module; and generate an action command to provide a control operation of the battery module as a function of the operating condition.

In an aspect, a method of battery pack management using a module monitor unit (MMU), the method including: receiving, by a control circuit, a measurement datum of a battery module from a sensor communicatively connected to an MMU; determining, by a control circuit, an operating condition of the battery module as a function of the measurement datum; and generating, by a control circuit, an action command to provide a control operation of the battery module as a function of the operating condition.

These and other aspects and features of non-limiting embodiments of the present invention will become apparent to those skilled in the art upon review of the following description of specific non-limiting embodiments of the invention in conjunction with the accompanying drawings.

### BRIEF DESCRIPTION OF THE DRAWINGS

For the purpose of illustrating the invention, the drawings show aspects of one or more embodiments of the invention. However, it should be understood that the present invention is not limited to the precise arrangements and instrumentalities shown in the drawings, wherein:

FIG. 1 is an block diagram of an exemplary embodiment of a module monitor unit in one or more aspect of the present disclosure;

FIG. 2 is an illustration of an exemplary embodiment of a sensor suite in partial cut-off view;

FIG. 3 is a block diagram of an exemplary embodiment of a battery pack in one or more aspects of the present disclosure;

FIGS. 4-5 are illustrations of exemplary embodiment of battery packs configured for use in an electric aircraft in isometric view in accordance with one or more aspects of the present disclosure;

FIG. 6 is a flow chart of an exemplary embodiment of a method of use for module monitor unit in one or more aspects of the present disclosure;

FIG. 7 is an illustration of an embodiment of an electric aircraft in one or more aspect of the present disclosure; and

FIG. 8 is a block diagram of a computing system that can be used to implement any one or more of the methodologies disclosed herein and any one or more portions thereof.

The drawings are not necessarily to scale and may be illustrated by phantom lines, diagrammatic representations and fragmentary views. In certain instances, details that are not necessary for an understanding of the embodiments or that render other details difficult to perceive may have been omitted.

### DETAILED DESCRIPTION

Battery management systems and related techniques are provided to improve the monitoring and controlling of an electric aircraft energy source. More specifically, a module monitor unit (MMU) is configured to measure a condition parameter of a component of an electric aircraft battery pack to ensure the battery pack is operating properly and to prevent and/or reduce damage to the electric aircraft if the battery pack experiences catastrophic failure.

In the following description, for the purposes of explanation, numerous specific details are set forth in order to provide a thorough understanding of the present invention. It will be apparent, however, that the present invention may be practiced without these specific details. As used herein, the word “exemplary” or “illustrative” means “serving as an example, instance, or illustration.” Any implementation described herein as “exemplary” or “illustrative” is not necessarily to be construed as preferred or advantageous over other implementations. Furthermore, there is no intention to be bound by any expressed or implied theory presented in the preceding technical field, background, brief summary or the following detailed description. It is also to be understood that the specific devices and processes illustrated in the attached drawings, and described in the following specification, are simply embodiments of the inventive concepts defined in the appended claims. Hence, specific dimensions and other physical characteristics relating to the embodiments disclosed herein are not to be considered as limiting, unless the claims expressly state otherwise.

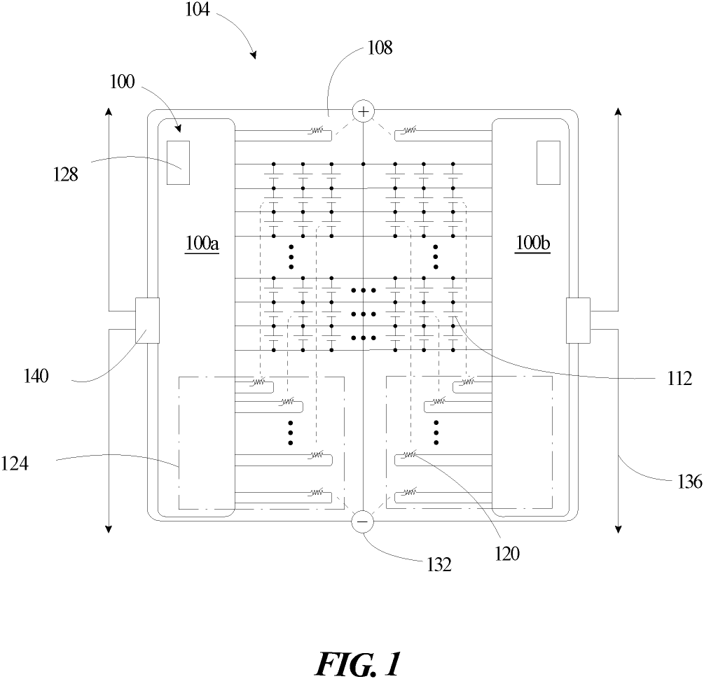

Referring now to FIG. 1, an exemplary embodiment of a module monitor unit (MMU) 100 is presented in accordance with one or more embodiments of the present disclosure. In one or more embodiments, MMU 100 is configured to monitor an operating condition of a battery pack 104. For example, and without limitation, MMU 100 may monitor an operating condition of a battery module 108 and/or a battery cell 112 of battery pack 104. In one or more embodiments, MMU 100 may be attached to battery module 108, as shown in FIG. 1. For example, and without limitation, MMU 100 may include a housing 116 that is attached to battery module 108, where circuit of MMU 100 may be disposed at least partially therein, as discussed further in this disclosure. In one or more embodiments, a housing may include a polymer, stainless steel, carbon steel, fiberglass, and polycarbonate. In other embodiments, MMU 100 may be remote to battery module 108.

In one or more embodiments, a plurality of MMUs 100 may be configured to monitor battery module 108 and/or battery cell 112. For instance, and without limitation, a first MMU 100a may be position at one end of battery module 108, and a second MMU 100b may be positioned at an opposing end of battery module 108. This arrangement may allow for redundancy in monitoring of battery cell 112. For example, and without limitation, if first MMU 100a fails, then second MMU 100b may continue to work properly and monitor the operating condition of each battery cell 112 of battery module 108. In one or more embodiments, MMU 100 may monitor the operating condition of a plurality of battery cells, as shown in FIG. 1.

In one or more embodiments, MMU 100 is configured to detect a measurement parameter of battery module 108. For the purposes of this disclosure, a “measurement parameter” is detected electrical or physical input, characteristic, and/or phenomenon related to a state of battery pack 104 and/or components thereof. For example, and without limitation, a measurement parameter may be a temperature, a voltage, a current, a moisture level/humidity, a gas level, or the like, as discussed further in this disclosure.

In one or more embodiments, MMU 100 is configured to perform cell balancing and/or load sharing during the charging of battery pack 104. Cell balancing may be used when a battery module includes a plurality of battery cells 112. Cell unbalance includes variances in charge and discharge of each battery cell depending on an operating condition of each battery cell 112. Cell unbalance may result in damage, such as degradation or premature charge termination, of a battery cell. For example, a battery cell with a higher SOC than other battery cells may be exposed to overvoltage during charging. Cell balancing may include compensating for a variance in SOC, internal impedance, total chemical capacity, or the like. For instance, MMU 100 may perform cell balancing for SOC and thus regulate voltage input of battery cells 112. For instance, and without limitation, charging of battery pack 104 may be shared throughout a plurality of battery cells 112 by directing electrical power through balance resistors and dissipating voltage through resistors as heat. For example, and without limitation, resistor may include a nonlinear resistor, such as a thermistor 120. Thermistor 120 may be configured to provide cell balancing by reducing a voltage supplied to a battery cell of the battery module. The reduction in the voltage supplied to the battery cell may be achieved via heat dissipation. In one or more non-limiting embodiments, MMU 100 may detect the charge of each battery and thermistors 120 of MMU 100 may be configured to reduce a current and/or voltage supplied to a battery cell 112 as a function of a temperature of the thermistor. For example, and without limitation, if a battery cell is being overcharged then the temperature of the connected circuit and thermistor may also experience and increase in temperature; as a result the thermistor may increase in resistance and a fraction of the supplied voltage across the thermistor will also change, which results in a decrease in voltage received by the battery cell. In this manner, battery cells 112 may be charged evenly during recharging and/or charging of battery pack 104 by, for example, a charging station or an electric grid. For example, and without limitation, battery cells with a lower SOC will charge more than battery cells with a greater SOC by thermistors 120 dissipating voltage to the battery cells with the greater SOC. In one or more embodiments, cell balancing may be equally distributed, where each battery cell receives an equal amount of electricity depending on how many amps are available from the charger and how many cells need to be charged. For example, and without limitation, a current may be equally distributed to each battery cell by MMU 100. In another embodiment, MMU 100 may detect an SOC of each battery cell and distribute current to each battery cell in various amounts as a function of the detected SOC of each battery cell. For example, and without limitation, MMU may detect that a first battery cell has an SOC of 20% and a second battery cell has as SOC of 80%. During recharging, the current and/or voltage to the first battery may be increased so that first battery cell is charged faster than the second battery cell. In one or more non-limiting embodiments, once first battery cell is at the same SOC as the second battery cell during recharging, distribution of current and/or voltage to each battery cell may be adjusted again so that the first battery cell and the second battery cell receive an equal charge. In one or more embodiments, MMU 100 is configured to monitor a temperature of battery module 108. For example, MMU 100 may include a sensor 124 configured to detect a temperature parameter of battery cell 112. For example, and without limitation, sensor 124 may include thermistor 120, which may be used to measure a temperature parameter of battery cell 112. As used in this disclosure, a thermistor includes a resistor having a resistance dependent on temperature. In one or more embodiments, sensor 124 may include circuitry configured to generate a measurement datum correlated to the detected measurement parameter, such as a temperature of battery cell 112 detected by thermistor 120. A thermistor may include metallic oxides, epoxy, glass, and the like. A thermistor may include a negative temperature coefficient (NTC) or a positive temperature coefficient (PTC). Thermistors may be beneficial do to being durable, compact, inexpensive, and relatively accurate. In one or more embodiments, a plurality of thermistors 120 may be used to provide redundant measuring of a state of battery cell 112, such as temperature. In other embodiments, MMU 100 may also include a resistance temperature detector (RTD), integrated circuit, thermocouple, thermometer, microbolometer, a thermopile infrared sensor, and/or other temperature and/or thermal sensors, as discussed further below in this disclosure. In one or more embodiments, thermistor 120 may detect a temperature of battery cell 112. Subsequently, MMU 100 may generate a sensor signal output containing information related to the detected temperature of battery cell 112. In one or more embodiments, sensor signal output may include measurement datum containing information representing a detected measurement parameter.

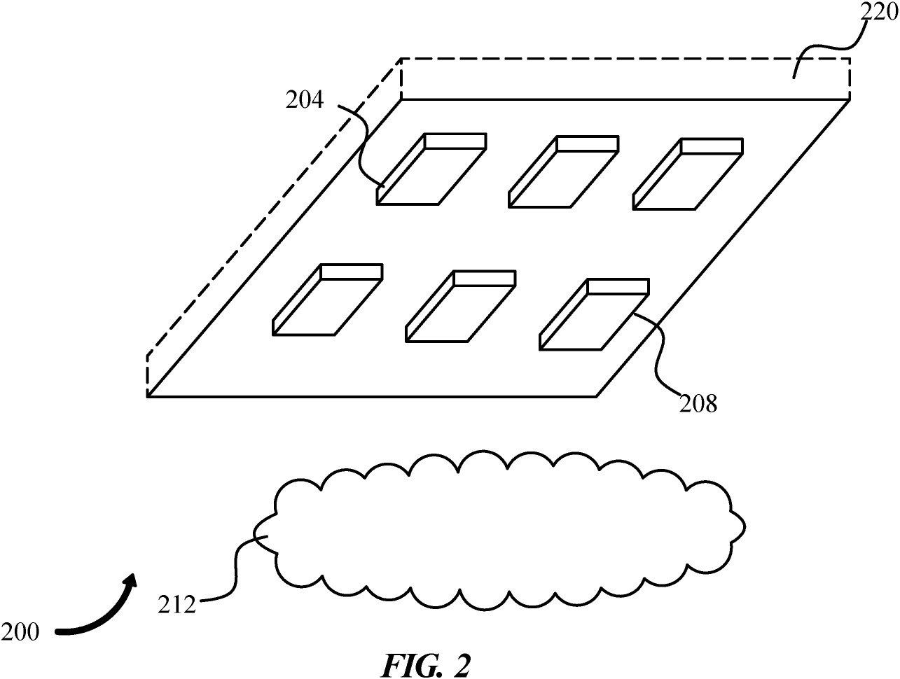

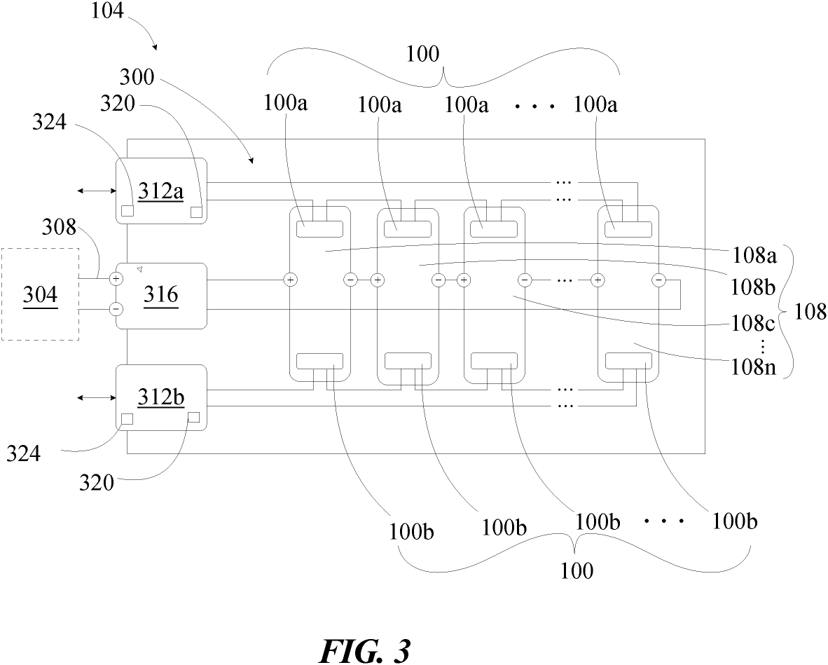

In one or more embodiments, sensor 124 may include a sensor suite 200 (shown in FIG. 2) or one or more individual sensors, which may include, but are not limited to, one or more temperature sensors, voltmeters, current sensors, hydrometers, infrared sensors, photoelectric sensors, ionization smoke sensors, motion sensors, pressure sensors, radiation sensors, level sensors, imaging devices, moisture sensors, gas and chemical sensors, flame sensors, electrical sensors, imaging sensors, force sensors, Hall sensors, airspeed sensors, throttle position sensors, and the like. Sensor 124 may be a contact or a non-contact sensor. For example, and without limitation, sensor 124 may be connected to battery module 108 and/or battery cell 112. In other embodiments, sensor 124 may be remote to battery module and/or battery cell 112. Sensor 124 may be communicatively connected to controller 320 of PMU 312 (shown in FIG. 3) so that sensor 124 may transmit/receive signals to/from controller 320, respectively, as discussed below in this disclosure. Signals, such as signals of sensor 124 and controller 320, may include electrical, electromagnetic, visual, audio, radio waves, or another undisclosed signal type alone or in combination. In one or more embodiments, communicatively connecting is a process whereby one device, component, or circuit is able to receive data from and/or transmit data to another device, component, or circuit. In an embodiment, communicative connecting includes electrically connecting at least an output of one device, component, or circuit to at least an input of another device, component, or circuit.

In one or more embodiments, MMU 100 may include a control circuit that processes the received measurement datum from sensor 124, as shown in FIG. 3. In one or more embodiments, control circuit may be configured to perform and/or direct any actions performed by MMU 100 and/or any other component and/or element described in this disclosure. Control circuit may include any analog or digital control circuit, including without limitation a combinational and/or synchronous logic circuit, a processor, microprocessor, microcontroller, any combination thereof, or the like. In one or more embodiments, control circuit may be solely constructed from hardware; thus, control circuit may perform without using software. Not relying on software may increase durability and speed of control circuit while reducing costs. For example, and without limitations, control circuit may include logic gates and/or thermistors, as discussed further in this disclosure. In some embodiments, control circuit 128 may be integrated into MMU 100, as shown in FIG. 1. In other embodiments, control circuit 128 may be remote to MMU 100. In one or more nonlimiting exemplary embodiments, if measurement datum of a temperature of a battery module 108, such as at a terminal 132, is higher than a predetermined threshold, control circuit 128 may determine that the temperature of battery cell 112 indicates a critical event and thus is malfunctioning. For example, a high voltage (HV) electrical connection of battery module terminal 132 may be short circuiting. If control circuit 128 determines that a HV electrical connection is malfunctioning, control circuit 128 may terminate a physical and/or electrical communication of the HV electrical connection to prevent a dangerous or detrimental reaction, such as a short, that may result in an electrical shock, damage to battery pack 104, or even a fire. Thus, control circuit 128 may trip a circuit of battery pack 104 and terminate power flow through the faulty battery module 108 until the detected fault is corrected and/or the excessively high temperature is no longer detected. Temperature sensors, such as thermistor 120 may assist in the monitoring of a cell group’s overall temperature, an individual battery cell’s temperature, and/or battery module’s temperature, as just described above.

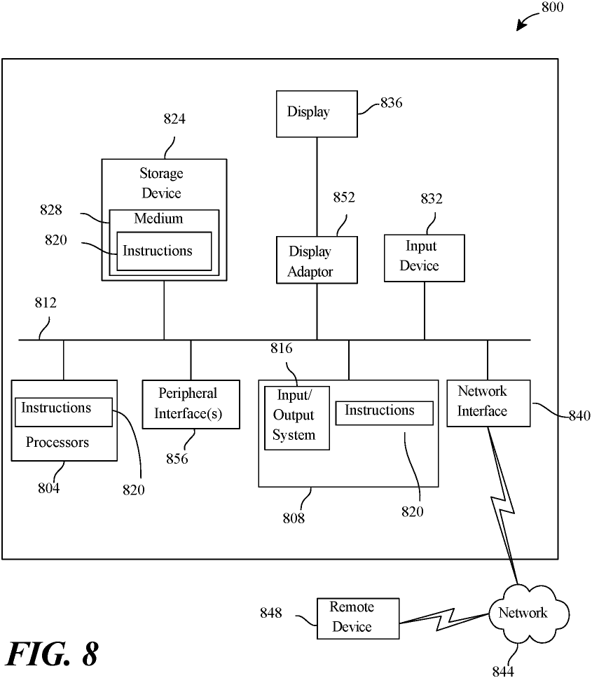

In one or more embodiments, MMU 100 may not use software. For example, MMU 100 may not use software to improve reliability and durability of MMU 100. Rather, MMU 100 may be communicatively connected to a remote computing device, such as computing device 800 of FIG. 8. In one or more embodiments, MMU 100 may include one or more circuits and/or circuit elements, including without limitation a printed circuit board component, aligned with a first side of battery module 108 and the openings correlating to battery cells 112. In one or more embodiments, MMU 100 may be communicatively connected to a remote processing module, such as a controller. Controller may be configured to perform appropriate processing of detected temperature characteristics by sensor 124. In one or more embodiments, controller ** may include an application-specific integrated circuit (ASIC), field-programmable gate array (FPGA), a central processing unit (CPU), readout integrated circuit (ROIC), or the like, and may be configured to perform characteristic processing to determine a temperature and/or critical event of battery module 108. In these and other embodiments, controller may operate in conjunction with other components, such as, a memory component, where a memory component includes a volatile memory and/or a non-volatile memory.

In one or more embodiments, each MMU 100 may communicate with another MMU 100 and/or a controller via a communicative connection 136. Each MMU may use a wireless and/or wired connection to communicated with each other. For example, and without limitation, MMU 100a may communicate with an adjacent MMU 100a using an isoSPI connection 304 (shown in FIG. 3). As understood by one skilled in the art, and isoSPI connection may include a transformer to magnetically connect and electrically isolate a signal between communicating devices.

Referring now to FIG. 2, an embodiment of sensor suite 200 is presented. The herein disclosed system and method may comprise a plurality of sensors in the form of individual sensors or a sensor suite working in tandem or individually. A sensor suite may include a plurality of independent sensors, as described herein, where any number of the described sensors may be used to detect any number of physical or electrical quantities associated with an aircraft power system or an electrical energy storage system. Independent sensors may include separate sensors measuring physical or electrical quantities that may be powered by and/or in communication with circuits independently, where each may signal sensor output to a control circuit such as a user graphical interface. In a non-limiting example, there may be four independent sensors housed in and/or on battery pack 104 measuring temperature, electrical characteristic such as voltage, amperage, resistance, or impedance, or any other parameters and/or quantities as described in this disclosure. In an embodiment, use of a plurality of independent sensors may result in redundancy configured to employ more than one sensor that measures the same phenomenon, those sensors being of the same type, a combination of, or another type of sensor not disclosed, so that in the event one sensor fails, the ability of battery management system 100 and/or user to detect phenomenon is maintained and in a non-limiting example, a user alter aircraft usage pursuant to sensor readings.

Sensor suite 200 may be suitable for use as sensor 124 as disclosed with reference to FIG. 1 hereinabove. Sensor suite 200 includes a moisture sensor 204. “Moisture”, as used in this disclosure, is the presence of water, this may include vaporized water in air, condensation on the surfaces of objects, or concentrations of liquid water. Moisture may include humidity. “Humidity”, as used in this disclosure, is the property of a gaseous medium (almost always air) to hold water in the form of vapor. An amount of water vapor contained within a parcel of air can vary significantly. Water vapor is generally invisible to the human eye and may be damaging to electrical components. There are three primary measurements of humidity, absolute, relative, specific humidity. “Absolute humidity,” for the purposes of this disclosure, describes the water content of air and is expressed in either grams per cubic meters or grams per kilogram. “Relative humidity”, for the purposes of this disclosure, is expressed as a percentage, indicating a present stat of absolute humidity relative to a maximum humidity given the same temperature. “Specific humidity”, for the purposes of this disclosure, is the ratio of water vapor mass to total moist air parcel mass, where parcel is a given portion of a gaseous medium. Moisture sensor 204 may be psychrometer. Moisture sensor 204 may be a hygrometer. Moisture sensor 204 may be configured to act as or include a humidistat. A “humidistat”, for the purposes of this disclosure, is a humidity-triggered switch, often used to control another electronic device. Moisture sensor 204 may use capacitance to measure relative humidity and include in itself, or as an external component, include a device to convert relative humidity measurements to absolute humidity measurements. “Capacitance”, for the purposes of this disclosure, is the ability of a system to store an electric charge, in this case the system is a parcel of air which may be near, adjacent to, or above a battery cell.

With continued reference to FIG. 2, sensor suite 200 may include electrical sensors 208. Electrical sensors 208 may be configured to measure voltage across a component, electrical current through a component, and resistance of a component. Electrical sensors 208 may include separate sensors to measure each of the previously disclosed electrical characteristics such as voltmeter, Rogowski coil and corresponding integrator circuit, ammeter, and ohmmeter, and the like.

Alternatively or additionally, and with continued reference to FIG. 2, sensor suite 200 include a sensor or plurality thereof that may detect voltage and direct the charging of individual battery cells according to charge level; detection may be performed using any suitable component, set of components, and/or mechanism for direct or indirect measurement and/or detection of voltage levels, including without limitation comparators, analog to digital converters, any form of voltmeter, or the like. Sensor suite 200 and/or a control circuit incorporated therein and/or communicatively connected thereto may be configured to adjust charge to one or more battery cells as a function of a charge level and/or a detected parameter. For instance, and without limitation, sensor suite 200 may be configured to determine that a charge level of a battery cell is high based on a detected voltage level of that battery cell or portion of the battery pack. Sensor suite 200 may alternatively or additionally detect a charge reduction event, defined for purposes of this disclosure as any temporary or permanent state of a battery cell requiring reduction or cessation of charging; a charge reduction event may include a cell being fully charged and/or a cell undergoing a physical and/or electrical process that makes continued charging at a current voltage and/or current level inadvisable due to a risk that the cell will be damaged, will overheat, or the like. Detection of a charge reduction event may include detection of a temperature, of the cell above a threshold level, detection of a voltage and/or resistance level above or below a threshold, or the like. Sensor suite 200 may include digital sensors, analog sensors, or a combination thereof. Sensor suite 200 may include digital-to-analog converters (DAC), analog-to-digital converters (ADC, A/D, A-to-D), a combination thereof, or other signal conditioning components used in transmission of a first plurality of battery pack data 128 to a destination over wireless or wired connection.

With continued reference to FIG. 2, sensor suite 200 may include thermocouples, thermistors, thermometers, passive infrared sensors, resistance temperature sensors (RTDs), semiconductor based integrated circuits (IC), a combination thereof or another undisclosed sensor type, alone or in combination. Temperature, for the purposes of this disclosure, and as would be appreciated by someone of ordinary skill in the art, is a measure of the heat energy of a system. Temperature, as measured by any number or combinations of sensors present within sensor suite 200, may be measured in Fahrenheit (°F), Celsius (°C), Kelvin (°K), or another scale alone or in combination. The temperature measured by sensors may comprise electrical signals which are transmitted to their appropriate destination wireless or through a wired connection.

With continued reference to FIG. 2, sensor suite 200 may include a sensor configured to detect gas that may be emitted during or after a cell failure. “Cell failure”, for the purposes of this disclosure, refers to a malfunction of a battery cell, which may be an electrochemical cell, that renders the cell inoperable for its designed function, namely providing electrical energy to at least a portion of an electric aircraft. Byproducts of cell failure 212 may include gaseous discharge including oxygen, hydrogen, carbon dioxide, methane, carbon monoxide, a combination thereof, or another undisclosed gas, alone or in combination. Further the sensor configured to detect vent gas from electrochemical cells may comprise a gas detector. For the purposes of this disclosure, a “gas detector” is a device used to detect a gas is present in an area. Gas detectors, and more specifically, the gas sensor that may be used in sensor suite 200, may be configured to detect combustible, flammable, toxic, oxygen depleted, a combination thereof, or another type of gas alone or in combination. The gas sensor that may be present in sensor suite 200 may include a combustible gas, photoionization detectors, electrochemical gas sensors, ultrasonic sensors, metal-oxide-semiconductor (MOS) sensors, infrared imaging sensors, a combination thereof, or another undisclosed type of gas sensor alone or in combination. Sensor suite 200 may include sensors that are configured to detect non-gaseous byproducts of cell failure 212 including, in non-limiting examples, liquid chemical leaks including aqueous alkaline solution, ionomer, molten phosphoric acid, liquid electrolytes with redox shuttle and ionomer, and salt water, among others. Sensor suite 200 may include sensors that are configured to detect non-gaseous byproducts of cell failure 212 including, in non-limiting examples, electrical anomalies as detected by any of the previous disclosed sensors or components.

With continued reference to FIG. 2, sensor suite 200 may be configured to detect events where voltage nears an upper voltage threshold or lower voltage threshold. The upper voltage threshold may be stored in memory component 324 for comparison with an instant measurement taken by any combination of sensors present within sensor suite 200. The upper voltage threshold may be calculated and calibrated based on factors relating to battery cell health, maintenance history, location within battery pack, designed application, and type, among others. Sensor suite 200 may measure voltage at an instant, over a period of time, or periodically. Sensor suite 200 may be configured to operate at any of these detection modes, switch between modes, or simultaneous measure in more than one mode. In one or more exemplary embodiments, PMU 312 may determine, using sensor suite 200, a critical event element where voltage nears the lower voltage threshold. The lower voltage threshold may indicate power loss to or from an individual battery cell or portion of the battery pack. PMU 312 may determine through sensor suite 200 critical event elements where voltage exceeds the upper and lower voltage threshold. Events where voltage exceeds the upper and lower voltage threshold may indicate battery cell failure or electrical anomalies that could lead to potentially dangerous situations for aircraft and personnel that may be present in or near its operation.

In one or more embodiments, sensor suite 200 may include an inertial measurement unit (IMU). In one or more embodiments, an IMU may be configured to detect a change in specific force of a body. An IMU may include an accelerometer, a gyro sensor, a magnetometer, an E-compass, a G-sensor, a geomagnetic sensor, and the like. An IMU may be configured to obtain measurement datum. PMU 312 may determine a critical event element by if, for example, an accelerometer of sensor suite 200 detects a force experienced by battery pack 104 that exceeds a predetermined threshold.

Now referring to FIG. 3, a battery pack 104 with a battery management component 300 that utilizes MMU 100 for monitoring a status of battery pack is shown in accordance with one or more embodiments of the present disclosure. In one or more embodiments, electric aircraft battery pack 104 may include a battery module 108, which is configured to provide energy to an electric aircraft 304 via a power supply connection 308. For the purposes of this disclosure, a “power supply connection” is an electrical and/or physical communication between a battery module 108 and electric aircraft 304 that powers electric aircraft 304 and/or electric aircraft subsystems for operation. In one or more embodiments, battery pack 104 may include a plurality of battery modules, such as modules 108a-n. For example, and without limitation, battery pack 104 may include fourteen battery modules. In one or more embodiments, each battery module 108a-n may include a battery cell 112 (shown in FIG. 1).

Still referring to FIG. 3, battery pack 104 may include a battery management component 120 (also referred to herein as a “management component”). In one or more embodiments, battery management component 300 may be integrated into battery pack 104 in a portion of battery pack 104 or a subassembly thereof. In an exemplary embodiment, and without limitation, management component 300 may be disposed on a first end of battery pack 104. One of ordinary skill in the art will appreciate that there are various areas in and on a battery pack and/or subassemblies thereof that may include battery management component 300. In one or more embodiments, battery management component 300 may be disposed directly over, adjacent to, facing, and/or near a battery module and specifically at least a portion of a battery cell. In one or more embodiments, battery management component 300 includes module monitor unit (MMU) 100, a pack monitoring unit (PMU) 312, and a high voltage disconnect 316. In one or more embodiments, battery management component 300 may also include a sensor 124. For example, and without limitation, battery management component 300 may include a sensor suite 200 having a plurality of sensors, as discussed further in this disclosure, as shown in FIG. 2.

In one or more embodiments, MMU 100 may be mechanically connected and communicatively connected to battery module 108. As used herein, “communicatively connected” is a process whereby one device, component, or circuit is able to receive data from and/or transmit data to another device, component, or circuit. In an embodiment, communicative connecting includes electrically connecting at least an output of one device, component, or circuit to at least an input of another device, component, or circuit. In one or more embodiments, MMU 100 is configured to detect a measurement characteristic of battery module 108 of battery pack 104. For the purposes of this disclosure, a “measurement characteristic” is detected electrical or physical input and/or phenomenon related to a condition state of battery pack 104. A condition state may include detectable information related to, for example, a temperature, a moisture level, a humidity, a voltage, a current, vent gas, vibrations, chemical content, or other measurable characteristics of battery pack 104, battery module 108, and/or battery cell 112. For example, and without limitation, MMU 100 may detect and/or measure a measurement characteristic, such as a temperature, of battery module 108. In one or more embodiments, a condition state of battery pack 104 may include a condition state of a battery module 108 and/or battery cell 112. In one or more embodiments, MMU 100 may include a sensor, which may be configured to detect and/or measure measurement characteristic. As used in this disclosure, a “sensor” is a device that is configured to detect an input and/or a phenomenon and transmit information and/or datum related to the detection, as discussed further below in this disclosure. Output signal may include a sensor signal, which transmits information and/or datum related to the sensor detection. A sensor signal may include any signal form described in this disclosure, for example digital, analog, optical, electrical, fluidic, and the like. In some cases, a sensor, a circuit, and/or a controller may perform one or more signal processing steps on a signal. For instance, sensor, circuit, and/or controller may analyze, modify, and/or synthesize a signal in order to improve the signal, for instance by improving transmission, storage efficiency, or signal to noise ratio.

In one or more embodiments, MMU 100 is configured to transmit a measurement datum of battery module 108. MMU 100 may generate an output signal such as measurement datum that includes information regarding detected measurement characteristic. For the purposes of this disclosure, “measurement datum” is an electronic signal representing an information and/or a parameter of a detected electrical and/or physical characteristic and/or phenomenon correlated with a condition state of battery pack 104. In one or more embodiments, measurement datum may include temperature value, current value, voltage value, humidity level, pressure level, chemical/byproduct level, vent gas detection, and other information regarding detected characteristics. For example, measurement datum may include data of a measurement characteristic regarding a detected temperature of battery cell 112. In one or more embodiments, measurement datum may be transmitted by MMU 100 to PMU 312 so that PMU 312 may receive measurement datum, as discussed further in this disclosure. For example, MMU 100 may transmit measurement data to a controller 320 of PMU 312.

In one or more embodiments, MMU 100 may include a plurality of MMUs. For instance, and without limitation, each battery module 108a-n may include one or more MMUs 100. For example, and without limitation, each battery module 108a-n may include two MMUs 100a,b. MMUs 100a,b may be positioned on opposing sides of battery module 108. Battery module 108 may include a plurality of MMUs to create redundancy so that, if one MMU fails or malfunctions, another MMU may still operate properly. In one or more nonlimiting exemplary embodiments, MMU 100 may include mature technology so that there is a low risk. Furthermore, MMU 100 may not include software, for example, to avoid complications often associated with programming. MMU 100 is configured to monitor and balance all battery cell groups of battery pack 104 during charging of battery pack 104. For instance, and without limitation, MMU 100 may monitor a temperature of battery module 108 and/or a battery cell of battery module 108. For example, and without limitation, MMU may monitor a battery cell group temperature. In another example, and without limitation, MMU 100 may monitor a terminal temperature to, for example, detect a poor HV electrical connection. In one or more embodiments, an MMU 100 may be indirectly connected to PMU 312. In other embodiments, MMU 100 may be directly connected to PMU 312. In one or more embodiments, MMU 100 may be communicatively connected to an adjacent MMU 100.

Still referring to FIG. 3, battery management component 300 includes a pack monitoring unit (PMU) 128 may be connected to MMU 100. In one or more embodiments, PMU 312 includes a controller 320, which is configured to receive measurement datum from MMU 100, as previously discussed in this disclosure. For example, PMU 312a may receive a plurality of measurement data from MMU 100a. Similarly, PMU 312b may receive a plurality of measurement data from MMU 100b. In one or more embodiments, PMU 312 may receive measurement datum from MMU 100 via communicative connections. For example, PMU 312 may receive measurement datum from MMU 100 via an isoSPI communications interface. In one or more embodiments, controller 320 of PMU 312 is configured to identify an operating of battery module 108 as a function of measurement datum. For the purposes of this disclosure, an “operating condition” is a state and/or working order of battery pack 104 and/or any components thereof. For example, and without limitation, an operating condition may include a state of charge (SoC), a depth of discharge (DoD), a temperature reading, a moisture level or humidity, a gas level, a chemical level, or the like. In one or more embodiments, controller 320 of PMU 312 is configured to determine a critical event element if operating condition is outside of a predetermined threshold (also referred to herein as a “predetermined threshold”). For the purposes of this disclosure, a “critical event element” is a failure and/or critical operating condition of a battery pack, battery cell, and/or battery module that may be harmful to battery pack 104 and/or electric aircraft 304. For instance, and without limitation, if an identified operating condition, such as a temperature of a battery cell 112 of battery pack 104, does not fall within a predetermined threshold, such as a range of acceptable, operational temperatures of the battery cell, then a critical event element is determined by controller 320 of PMU 312. For example, and without limitation, PMU may used measurement datum from MMU to identify a temperature of 95° F. for a battery cell. If the predetermined threshold is, for example, 75 to 90° F., then the determined operating condition is outside of the predetermined threshold, such as exceeding the upper temperature threshold of 90° F., and a critical event element is determined by controller 320. As used in this disclosure, a “predetermined threshold” is a limit and/or range of an acceptable quantitative value and/or representation related to a normal operating condition of a battery pack and/or components thereof. In one or more embodiments, an operating condition outside of the threshold is a critical operating condition, which triggers a critical event element, and an operating condition within the threshold is a normal operating condition that indicates that battery pack 104 is working properly. For example, and without limitation, if an operating condition of temperature exceeds a predetermined threshold, then battery pack is considered to be operating at a critical operating condition and may be at risk of overheating and experiencing a catastrophic failure.

In one or more embodiments, controller 320 of PMU 312 is configured to generate an action command if critical event element is determined by controller 320. For the purposes of this disclosure, a “action command” is a control signal, which is an electrical signal and/or transmission that represents a control command. Continuing the previously described example above, if an identified operating condition includes a temperature of 95° F., which exceeds a predetermined threshold, then controller 320 may determine a critical event element indicating that battery pack 104 is working at a critical temperature level and at risk of catastrophic failure. In one or more embodiments, critical event elements may include high shock/drop, overtemperature, undervoltage, high moisture, contactor welding, and the like.

In one or more embodiments, controller 320 may include a computing device (as discussed in FIG. 8), a central processing unit (CPU), a microprocessor, a digital signal processor (DSP), an application specific integrated circuit (ASIC), a control circuit, a combination thereof, or the like. In one or more embodiments, output signals from various components of battery pack 104 may be analog or digital. Controller 320 may convert output signals from MMU 100 and/or sensor 124 to a usable form by the destination of those signals. The usable form of output signals from MMUs and/or sensors, through processor may be either digital, analog, a combination thereof, or an otherwise unstated form. Processing may be configured to trim, offset, or otherwise compensate the outputs of sensor. Based on MMU and/or sensor output, controller can determine the output to send to a downstream component. Processor can include signal amplification, operational amplifier (OpAmp), filter, digital/analog conversion, linearization circuit, current-voltage change circuits, resistance change circuits such as Wheatstone Bridge, an error compensator circuit, a combination thereof or otherwise undisclosed components. In one or more embodiments, PMU 312 may run state estimation algorithms.

In one or more embodiments, MMU 100 may be implemented in battery management system 300 of battery pack 104. MMU 100 may include sensor 124, as previously mentioned above in this disclosure. For instance, and without limitation, MMU 100 may include a plurality of sensors. For example, MMU 100 may include thermistors 120 to detect a temperature of a corresponding battery module 108 and/or battery cell 112. MMU 100 may include sensor 120 or a sensor suite, such as sensor suite 200 of FIG. 2, that is configured to measure physical and/or electrical parameters of battery pack 104, such as without limitation temperature, voltage, current, orientation, or the like, of one or more battery modules and/or battery cells 112. MMU 100 may configured to generate a measurement datum of each battery cell 112, which a control circuit may ultimately use to determine a failure within battery module 108 and/or battery cell 112, such as a critical event element. Cell failure may be characterized by a spike in temperature and MMU 100 may be configured to detect that increase, which in turn, PMU 312 uses to determine a critical event element and generate signals, to disconnect a power supply connection between electric aircraft ** and battery cell 112 and to notify users, support personnel, safety personnel, maintainers, operators, emergency personnel, aircraft computers, or a combination thereof. In one or more embodiments, measurement data of MMU may be stored in memory component 324.

Still referring to FIG. 3, battery management component 300 may include high voltage disconnect 132 , which is communicatively connected to battery module 108, wherein high voltage disconnect 132 is configured to terminate power supply connection 112 between battery module 108 and electric aircraft 304 in response to receiving action command from PMU 312. PMU 312 may be configured to determine a critical event element, such as high shock/drop, overtemperature, undervoltage, contactor welding, and the like. High voltage disconnect 132 is configured to receive action command generated by PMU 312 and execute a control operation as a function of the action command. For the purposes of this disclosure, a “control operation” is a performance of an action related to an action command. For example, and without limitation, high voltage disconnect may execute a control operation that includes a lock out of battery pack 104 for maintenance. In one or more embodiments, PMU 312 may create a lockout flag, which may be saved across reboots. A lockout flag may include an indicator alerting a user of termination of power supply connection 112 by high voltage disconnect 132. For instance, and without limitation, a lockout flag may be saved in a database od PMU 312 so that, despite rebooting battery pack 104 or complete loss of power of battery pack 104, power supply connection remains terminated and an alert regarding the termination remains. In one or more embodiments, lockout flag cannot be removed until a critical event element is no longer determined by controller 320. For, example, PMU 312 may be continuously updating an operating condition and determining if operating condition is outside of a predetermined threshold. In one or more embodiments, lockout flag may include an alert on a graphic user interface of, for example, a remote computing device, such as a mobile device, tablet, laptop, desktop and the like. In other embodiments, lockout flag may be indicated to a user via an illuminated LED that is remote or locally located on battery pack 104. In one or more embodiments, PMU 312 may include control of cell group balancing via MMUs, control of contactors (high voltage connections, etc.) control of welding detection, control of pyro fuses, and the like.

In one or more embodiments, battery management component 300 may include a plurality of PMUs 312. For instance, and without limitation, battery management component 300 may include a pair of PMUs. For example, and without limitation, battery management component 300 may include a first PMU 312a and a second PMU 312b, which are each disposed in or on battery pack 104 and may be physically isolated from each other. “Physical isolation”, for the purposes of this disclosure, refer to a first system’s components, communicative connection, and any other constituent parts, whether software or hardware, are separated from a second system’s components, communicative coupling, and any other constituent parts, whether software or hardware, respectively. Continuing in reference to the nonlimiting exemplary embodiment, first PMU 312a and second PMU 312b may perform the same or different functions. For example, and without limitation, the first and second PMUs 312a,b may perform the same, and therefore, redundant functions. Thus, if one PMU 312a/b fails or malfunctions, in whole or in part, the other PMU 312b/a may still be operating properly and therefore battery management component 300 may still operate and function properly for battery pack 104. One of ordinary skill in the art would understand that the terms “first” and “second” do not refer to either PMU as primary or secondary. In non-limiting embodiments, the first and second PMUs 312a,b, due to their physical isolation, may be configured to withstand malfunctions or failures in the other system and survive and operate. Provisions may be made to shield first PMU 312a from PMU 312b other than physical location, such as structures and circuit fuses. In non-limiting embodiments, first PMU 312a, second PMU 312b, or subcomponents thereof may be disposed on an internal component or set of components within battery pack 104, such as on battery module sense board, as discussed further below in this disclosure.

Still referring to FIG. 3, first PMU 312a may be electrically isolated from second PMU 312b. “Electrical isolation”, for the purposes of this disclosure, refer to a first system’s separation of components carrying electrical signals or electrical energy from a second system’s components. First PMU 312a may suffer an electrical catastrophe, rendering it inoperable, and due to electrical isolation, second PMU 312b may still continue to operate and function normally, allowing for continued management of battery pack 104 of electric aircraft 304. Shielding such as structural components, material selection, a combination thereof, or another undisclosed method of electrical isolation and insulation may be used, in nonlimiting embodiments. For example, and without limitation, a rubber or other electrically insulating material component may be disposed between electrical components of first and second PMUs 312a,b, preventing electrical energy to be conducted through it, isolating the first and second PMUs 312a,b form each other.

With continued reference to FIG. 3, battery management component 300 may include memory component 324, as previously mentioned above in this disclosure. In one or more embodiments, memory component 324 may be configured to store datum related to battery pack 104, such as data related to battery modules 108a-n and/or battery cells 112. For example, and without limitation, memory component 324 may store sensor datum, measurement datum, operation condition, critical event element, lockout flag, and the like. Memory component 324 may include a database. Memory component 324 may include a solid-state memory or tape hard drive. Memory component 324 may be communicatively connected to PMU 312 and may be configured to receive electrical signals related to physical or electrical phenomenon measured and store those electrical signals as battery module data. Alternatively, memory component 324 may be a plurality of discrete memory components that are physically and electrically isolated from each other. One of ordinary skill in the art would understand the virtually limitless arrangements of data stores with which battery pack 104 could employ to store battery pack data.

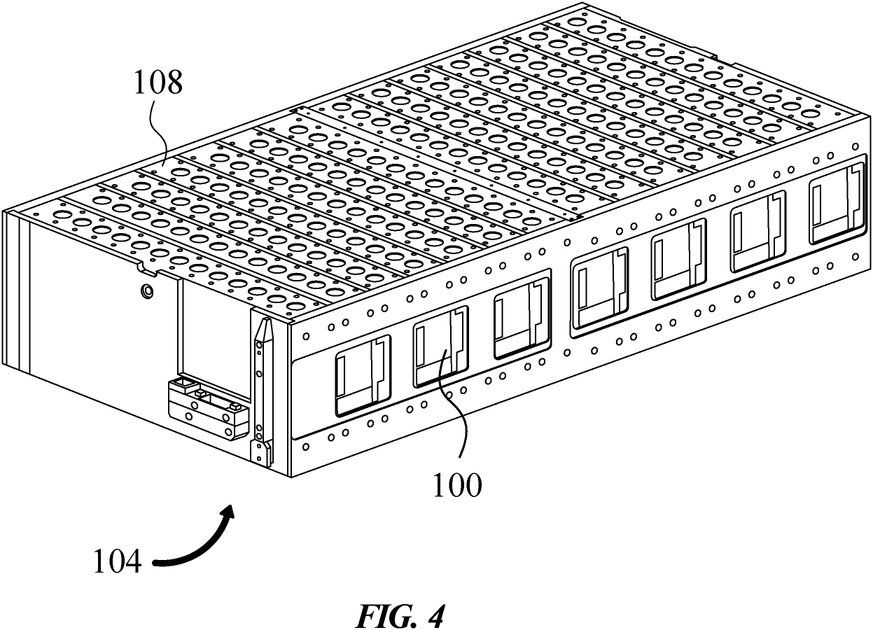

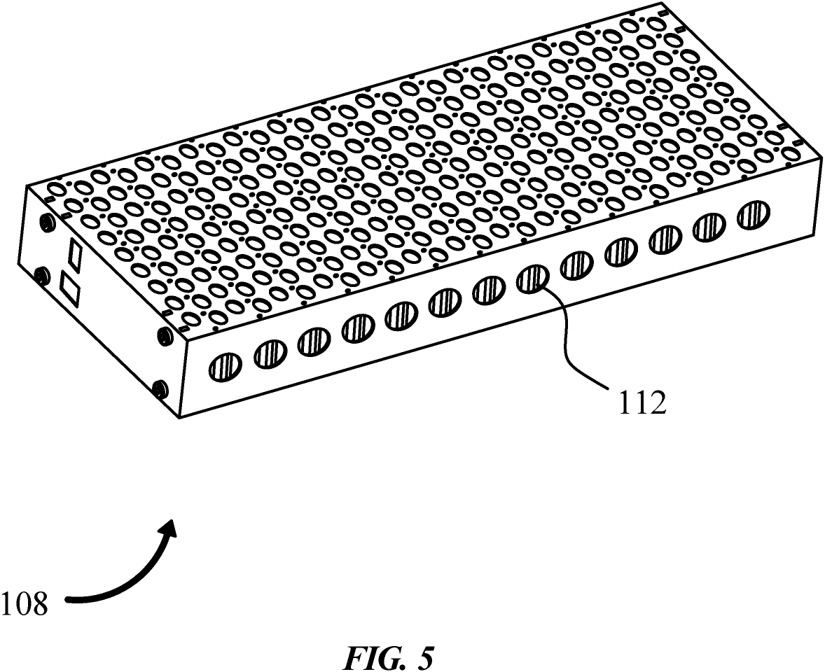

Now referring to FIGS. 4 and 5, exemplary embodiments of an eVTOL aircraft battery pack 104 and battery module 108, respectively, are illustrated. Battery pack 104 is a power source that may be configured to store electrical energy in the form of a plurality of battery modules, which themselves include of a plurality of electrochemical cells. These cells may utilize electrochemical cells, galvanic cells, electrolytic cells, fuel cells, flow cells, and/or voltaic cells. In general, an electrochemical cell is a device capable of generating electrical energy from chemical reactions or using electrical energy to cause chemical reactions, this disclosure will focus on the former. Voltaic or galvanic cells are electrochemical cells that generate electric current from chemical reactions, while electrolytic cells generate chemical reactions via electrolysis. In general, the term ‘battery’ is used as a collection of cells connected in series or parallel to each other. A battery cell may, when used in conjunction with other cells, may be electrically connected in series, in parallel or a combination of series and parallel. Series connection includes wiring a first terminal of a first cell to a second terminal of a second cell and further configured to include a single conductive path for electricity to flow while maintaining the same current (measured in Amperes) through any component in the circuit. A battery cell may use the term ‘wired’, but one of ordinary skill in the art would appreciate that this term is synonymous with ‘electrically connected’, and that there are many ways to couple electrical elements like battery cells together. An example of a connector that does not include wires may be prefabricated terminals of a first gender that mate with a second terminal with a second gender. Battery cells may be wired in parallel. Parallel connection includes wiring a first and second terminal of a first battery cell to a first and second terminal of a second battery cell and further configured to include more than one conductive path for electricity to flow while maintaining the same voltage (measured in Volts) across any component in the circuit. Battery cells may be wired in a series-parallel circuit which combines characteristics of the constituent circuit types to this combination circuit. Battery cells may be electrically connected in a virtually unlimited arrangement which may confer onto the system the electrical advantages associated with that arrangement such as high-voltage applications, high-current applications, or the like. In an exemplary embodiment, battery pack 104 include 196 battery cells in series and 18 battery cells in parallel. This is, as someone of ordinary skill in the art would appreciate, is only an example and battery pack 104 may be configured to have a near limitless arrangement of battery cell configurations.

With continued reference to FIGS. 4 and 5, battery pack 104 may include a plurality of battery modules. The battery modules may be wired together in series and in parallel. Battery pack 104 may include a center sheet which may include a thin barrier. The barrier may include a fuse connecting battery modules on either side of the center sheet. The fuse may be disposed in or on the center sheet and configured to connect to an electric circuit comprising a first battery module and therefore battery unit and cells. In general, and for the purposes of this disclosure, a fuse is an electrical safety device that operate to provide overcurrent protection of an electrical circuit. As a sacrificial device, its essential component is metal wire or strip that melts when too much current flows through it, thereby interrupting energy flow. The fuse may include a thermal fuse, mechanical fuse, blade fuse, expulsion fuse, spark gap surge arrestor, varistor, or a combination thereof.

Battery pack 104 may also include a side wall includes a laminate of a plurality of layers configured to thermally insulate the plurality of battery modules from external components of battery pack 104. The side wall layers may include materials which possess characteristics suitable for thermal insulation as described in the entirety of this disclosure like fiberglass, air, iron fibers, polystyrene foam, and thin plastic films, to name a few. The side wall may additionally or alternatively electrically insulate the plurality of battery modules from external components of battery pack 104 and the layers of which may include polyvinyl chloride (PVC), glass, asbestos, rigid laminate, varnish, resin, paper, Teflon, rubber, and mechanical lamina. The center sheet may be mechanically coupled to the side wall in any manner described in the entirety of this disclosure or otherwise undisclosed methods, alone or in combination. The side wall may include a feature for alignment and coupling to the center sheet. This feature may include a cutout, slots, holes, bosses, ridges, channels, and/or other undisclosed mechanical features, alone or in combination.

With continued reference to FIGS. 4 and 5, battery pack 104 may also include an end panel including a plurality of electrical connectors and further configured to fix battery pack 104 in alignment with at least the side wall. The end panel may include a plurality of electrical connectors of a first gender configured to electrically and mechanically couple to electrical connectors of a second gender. The end panel may be configured to convey electrical energy from battery cells to at least a portion of an eVTOL aircraft. Electrical energy may be configured to power at least a portion of an eVTOL aircraft or include signals to notify aircraft computers, personnel, users, pilots, and any others of information regarding battery health, emergencies, and/or electrical characteristics. The plurality of electrical connectors may include blind mate connectors, plug and socket connectors, screw terminals, ring and spade connectors, blade connectors, and/or an undisclosed type alone or in combination. The electrical connectors of which the end panel includes may be configured for power and communication purposes. A first end of the end panel may be configured to mechanically couple to a first end of a first side wall by a snap attachment mechanism, similar to end cap and side panel configuration utilized in the battery module. To reiterate, a protrusion disposed in or on the end panel may be captured, at least in part, by a receptacle disposed in or on the side wall. A second end of end the panel may be mechanically coupled to a second end of a second side wall in a similar or the same mechanism.

With continued reference to FIG. 5, sensor suite 200 may be disposed in or on a portion of battery pack 104 near battery modules or battery cells. In one or more embodiments, PMU 312 may be configured to communicate with an electric aircraft, such as a flight controller of electric aircraft 304, using a controller area network (CAN), such as by using a CAN transceiver. In one or more embodiments, controller area network may include a bus. Bus may include an electrical bus. Bus may refer to power busses, audio busses, video busses, computing address busses, and/or data busses. Bus may be additionally or alternatively responsible for conveying electrical signals generated by any number of components within battery pack 104 to any destination on or offboard an electric aircraft. Battery management component may include wiring or conductive surfaces only in portions required to electrically couple bus to electrical power or necessary circuits to convey that power or signals to their destinations.

Outputs from sensors or any other component present within system may be analog or digital. Onboard or remotely located processors can convert those output signals from sensor suite to a usable form by the destination of those signals. The usable form of output signals from sensors, through processor may be either digital, analog, a combination thereof or an otherwise unstated form. Processing may be configured to trim, offset, or otherwise compensate the outputs of sensor suite. Based on sensor output, the processor can determine the output to send to downstream component. Processor can include signal amplification, operational amplifier (OpAmp), filter, digital/analog conversion, linearization circuit, current-voltage change circuits, resistance change circuits such as Wheatstone Bridge, an error compensator circuit, a combination thereof or otherwise undisclosed components.

With continued reference to FIGS. 4 and 5, any of the disclosed components or systems, namely battery pack 104, MMU, 100, PMU 312, and/or battery cell 112 may incorporate provisions to dissipate heat energy present due to electrical resistance in integral circuit. Battery pack 104 includes one or more battery element modules wired in series and/or parallel. The presence of a voltage difference and associated amperage inevitably will increase heat energy present in and around battery pack 104 as a whole. The presence of heat energy in a power system is potentially dangerous by introducing energy possibly sufficient to damage mechanical, electrical, and/or other systems present in at least a portion of exemplary aircraft 600. Battery pack 104 may include mechanical design elements, one of ordinary skill in the art, may thermodynamically dissipate heat energy away from battery pack 104. The mechanical design may include, but is not limited to, slots, fins, heat sinks, perforations, a combination thereof, or another undisclosed element.

Heat dissipation may include material selection beneficial to move heat energy in a suitable manner for operation of battery pack 104. Certain materials with specific atomic structures and therefore specific elemental or alloyed properties and characteristics may be selected in construction of battery pack 104 to transfer heat energy out of a vulnerable location or selected to withstand certain levels of heat energy output that may potentially damage an otherwise unprotected component. One of ordinary skill in the art, after reading the entirety of this disclosure would understand that material selection may include titanium, steel alloys, nickel, copper, nickel-copper alloys such as Monel, tantalum and tantalum alloys, tungsten and tungsten alloys such as Inconel, a combination thereof, or another undisclosed material or combination thereof. Heat dissipation may include a combination of mechanical design and material selection. The responsibility of heat dissipation may fall upon the material selection and design as disclosed above in regard to any component disclosed in this paper. The battery pack 104 may include similar or identical features and materials ascribed to battery pack 104 in order to manage the heat energy produced by these systems and components.

According to embodiments, the circuit disposed within or on battery pack 104 may be shielded from electromagnetic interference. The battery elements and associated circuit may be shielded by material such as mylar, aluminum, copper a combination thereof, or another suitable material. The battery pack 104 and associated circuit may include one or more of the aforementioned materials in their inherent construction or additionally added after manufacture for the express purpose of shielding a vulnerable component. The battery pack 104 and associated circuit may alternatively or additionally be shielded by location. Electrochemical interference shielding by location includes a design configured to separate a potentially vulnerable component from energy that may compromise the function of said component. The location of vulnerable component may be a physical uninterrupted distance away from an interfering energy source, or location configured to include a shielding element between energy source and target component. The shielding may include an aforementioned material in this section, a mechanical design configured to dissipate the interfering energy, and/or a combination thereof. The shielding comprising material, location and additional shielding elements may defend a vulnerable component from one or more types of energy at a single time and instance or include separate shielding for individual potentially interfering energies.

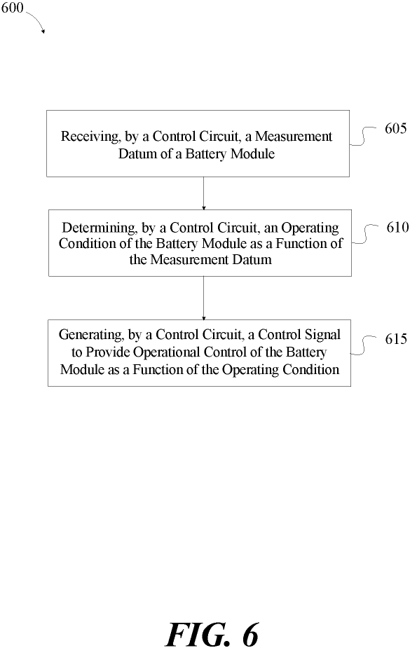

Referring now to FIG. 6, a flow chart showing an exemplary method 600 of battery pack management using MMU 100 in accordance with one or more embodiments of the present disclosure. In one or more embodiments, in step 605, method 600 includes receiving, by a control circuit, a measurement datum of a battery module from a sensor communicatively connected to an MMU. In step 610, method 600 includes determining, by a control circuit, an operating condition of the battery module as a function of the measurement datum. In one or more embodiments, method 600 may also include: detecting, by a sensor, a condition parameter of the battery module; and generating, by a sensor, the measurement datum as a function of the condition parameter. In one or more embodiments, the sensor may include a temperature sensor, such as thermistor 120, configured to detect a condition parameter, where the condition parameter comprises a temperature parameter.

In step 615, method 600 includes generating, by a control circuit, an action command to provide a control operation of the battery module as a function of the operating condition. In one or more embodiments, a control operation includes termination of a power supply connection between the battery module and the electric aircraft if the operating condition exceeds a predetermined temperature threshold.

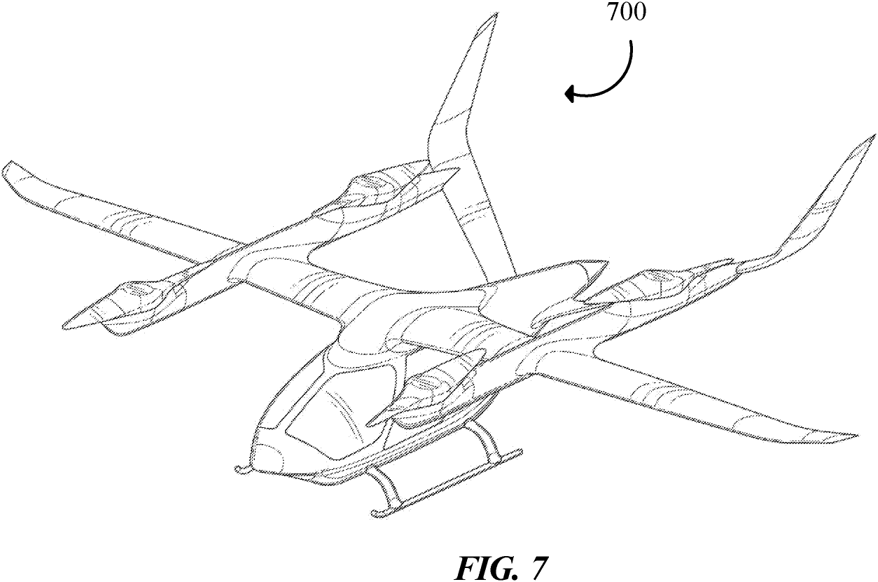

Referring now to FIG. 7, an embodiment of an electric aircraft 700 is presented in accordance with one or more embodiments of the present disclosure. Electric aircraft 700 may include a vertical takeoff and landing aircraft (eVTOL). As used herein, a vertical take-off and landing (eVTOL) aircraft is one that can hover, take off, and land vertically. An eVTOL, as used herein, is an electrically powered aircraft typically using an energy source, of a plurality of energy sources to power the aircraft. In order to optimize the power and energy necessary to propel the aircraft. eVTOL may be capable of rotor-based cruising flight, rotor-based takeoff, rotor-based landing, fixed-wing cruising flight, airplane-style takeoff, airplane-style landing, and/or any combination thereof. Rotor-based flight, as described herein, is where the aircraft generated lift and propulsion by way of one or more powered rotors coupled with an engine, such as a “quad copter,” multi-rotor helicopter, or other vehicle that maintains its lift primarily using downward thrusting propulsors. Fixed-wing flight, as described herein, is where the aircraft is capable of flight using wings and/or foils that generate life caused by the aircraft’s forward airspeed and the shape of the wings and/or foils, such as airplane-style flight.

It is to be noted that any one or more of the aspects and embodiments described herein may be conveniently implemented using one or more machines (e.g., one or more computing devices that are utilized as a user computing device for an electronic document, one or more server devices, such as a document server, etc.) programmed according to the teachings of the present specification, as will be apparent to those of ordinary skill in the computer art. Appropriate software coding can readily be prepared by skilled programmers based on the teachings of the present disclosure, as will be apparent to those of ordinary skill in the software art. Aspects and implementations discussed above employing software and/or software modules may also include appropriate hardware for assisting in the implementation of the machine executable instructions of the software and/or software module.

Such software may be a computer program product that employs a machine-readable storage medium. A machine-readable storage medium may be any medium that is capable of storing and/or encoding a sequence of instructions for execution by a machine (e.g., a computing device) and that causes the machine to perform any one of the methodologies and/or embodiments described herein. Examples of a machine-readable storage medium include, but are not limited to, a magnetic disk, an optical disc (e.g., CD, CD-R, DVD, DVD-R, etc.), a magneto-optical disk, a read-only memory “ROM” device, a random access memory “RAM” device, a magnetic card, an optical card, a solid-state memory device, an EPROM, an EEPROM, and any combinations thereof. A machine-readable medium, as used herein, is intended to include a single medium as well as a collection of physically separate media, such as, for example, a collection of compact discs or one or more hard disk drives in combination with a computer memory. As used herein, a machine-readable storage medium does not include transitory forms of signal transmission.

Such software may also include information (e.g., data) carried as a data signal on a data carrier, such as a carrier wave. For example, machine-executable information may be included as a data-carrying signal embodied in a data carrier in which the signal encodes a sequence of instruction, or portion thereof, for execution by a machine (e.g., a computing device) and any related information (e.g., data structures and data) that causes the machine to perform any one of the methodologies and/or embodiments described herein.

Examples of a computing device include, but are not limited to, an electronic book reading device, a computer workstation, a terminal computer, a server computer, a handheld device (e.g., a tablet computer, a smartphone, etc.), a web appliance, a network router, a network switch, a network bridge, any machine capable of executing a sequence of instructions that specify an action to be taken by that machine, and any combinations thereof. In one example, a computing device may include and/or be included in a kiosk.

FIG. 8 shows a diagrammatic representation of one embodiment of a computing device in the exemplary form of a computer system 800 within which a set of instructions for causing a control system to perform any one or more of the aspects and/or methodologies of the present disclosure may be executed. It is also contemplated that multiple computing devices may be utilized to implement a specially configured set of instructions for causing one or more of the devices to perform any one or more of the aspects and/or methodologies of the present disclosure. Computer system 800 includes a processor 804 and a memory 808 that communicate with each other, and with other components, via a bus 812. Bus 812 may include any of several types of bus structures including, but not limited to, a memory bus, a memory controller, a peripheral bus, a local bus, and any combinations thereof, using any of a variety of bus architectures.

Memory 808 may include various components (e.g., machine-readable media) including, but not limited to, a random-access memory component, a read only component, and any combinations thereof. In one example, a basic input/output system 816 (BIOS), including basic routines that help to transfer information between elements within computer system 800, such as during start-up, may be stored in memory 808. Memory 808 may also include (e.g., stored on one or more machine-readable media) instructions (e.g., software) 820 embodying any one or more of the aspects and/or methodologies of the present disclosure. In another example, memory 808 may further include any number of program modules including, but not limited to, an operating system, one or more application programs, other program modules, program data, and any combinations thereof.

Computer system 800 may also include a storage device 824. Examples of a storage device (e.g., storage device 824) include, but are not limited to, a hard disk drive, a magnetic disk drive, an optical disc drive in combination with an optical medium, a solid-state memory device, and any combinations thereof. Storage device 824 may be connected to bus 812 by an appropriate interface (not shown). Example interfaces include, but are not limited to, SCSI, advanced technology attachment (ATA), serial ATA, universal serial bus (USB), IEEE 894 (FIREWIRE), and any combinations thereof. In one example, storage device 824 (or one or more components thereof) may be removably interfaced with computer system 800 (e.g., via an external port connector (not shown)). Particularly, storage device 824 and an associated machine-readable medium 828 may provide nonvolatile and/or volatile storage of machine-readable instructions, data structures, program modules, and/or other data for computer system 800. In one example, software 820 may reside, completely or partially, within machine-readable medium 828. In another example, software 820 may reside, completely or partially, within processor 804.

Computer system 800 may also include an input device 832. In one example, a user of computer system 800 may enter commands and/or other information into computer system 800 via input device 832. Examples of an input device 832 include, but are not limited to, an alpha-numeric input device (e.g., a keyboard), a pointing device, a joystick, a gamepad, an audio input device (e.g., a microphone, a voice response system, etc.), a cursor control device (e.g., a mouse), a touchpad, an optical scanner, a video capture device (e.g., a still camera, a video camera), a touchscreen, and any combinations thereof. Input device 832 may be interfaced to bus 812 via any of a variety of interfaces (not shown) including, but not limited to, a serial interface, a parallel interface, a game port, a USB interface, a FIREWIRE interface, a direct interface to bus 812, and any combinations thereof. Input device 832 may include a touch screen interface that may be a part of or separate from display 836, discussed further below. Input device 832 may be utilized as a user selection device for selecting one or more graphical representations in a graphical interface as described above.

A user may also input commands and/or other information to computer system 800 via storage device 824 (e.g., a removable disk drive, a flash drive, etc.) and/or network interface device 840. A network interface device, such as network interface device 840, may be utilized for connecting computer system 800 to one or more of a variety of networks, such as network 844, and one or more remote devices 848 connected thereto. Examples of a network interface device include, but are not limited to, a network interface card (e.g., a mobile network interface card, a LAN card), a modem, and any combination thereof. Examples of a network include, but are not limited to, a wide area network (e.g., the Internet, an enterprise network), a local area network (e.g., a network associated with an office, a building, a campus or other relatively small geographic space), a telephone network, a data network associated with a telephone/voice provider (e.g., a mobile communications provider data and/or voice network), a direct connection between two computing devices, and any combinations thereof. A network, such as network 844, may employ a wired and/or a wireless mode of communication. In general, any network topology may be used. Information (e.g., data, software 820, etc.) may be communicated to and/or from computer system 800 via network interface device 840.

Computer system 800 may further include a video display adapter 852 for communicating a displayable image to a display device, such as display device 836. Examples of a display device include, but are not limited to, a liquid crystal display (LCD), a cathode ray tube (CRT), a plasma display, a light emitting diode (LED) display, and any combinations thereof. Display adapter 852 and display device 836 may be utilized in combination with processor 804 to provide graphical representations of aspects of the present disclosure. In addition to a display device, computer system. 800 may include one or more other peripheral output devices including, but not limited to, an audio speaker, a printer, and any combinations thereof. Such peripheral output devices may be connected to bus 812 via a peripheral interface 856. Examples of a peripheral interface include, but are not limited to, a serial port, a USB connection, a FIREWIRE connection, a parallel connection, and any combinations thereof.

The foregoing has been a detailed description of illustrative embodiments of the invention. Various modifications and additions can be made without departing from the spirit and scope of this invention. Features of each of the various embodiments described above may be combined with features of other described embodiments as appropriate in order to provide a multiplicity of feature combinations in associated new embodiments. Furthermore, while the foregoing describes a number of separate embodiments, what has been described herein is merely illustrative of the application of the principles of the present invention. Additionally, although particular methods herein may be illustrated and/or described as being performed in a specific order, the ordering is highly variable within ordinary skill to achieve embodiments according to this disclosure. Accordingly, this description is meant to be taken only by way of example, and not to otherwise limit the scope of this invention.

Exemplary embodiments have been disclosed above and illustrated in the accompanying drawings. It will be understood by those skilled in the art that various changes, omissions and additions may be made to that which is specifically disclosed herein without departing from the spirit and scope of the present invention.

1. An electric aircraft battery module comprising:
a first monitor module unit (MMU), the first MMU comprising:
a housing attached to a battery module of an electric aircraft, the battery module comprising a battery cell;
a control circuit at least partially disposed within the housing, the control circuit configured to:
receive a measurement datum of a battery module from a communicatively connected sensor;
determine an operating condition of the battery module; and
generate an action command to provide a control operation of the battery module as a function of the operating condition;
transmit a current operation condition to a first pack monitoring unit (PMU), wherein the first pack monitoring unit is communicatively connected to the first MMU; and
a second MMU, the second MMU configured to transmit the current operation condition to a second PMU, wherein the second PMU is communicatively connected to the second MMU. .

2. The battery module of claim 1, further comprising a thermistor, wherein the thermistor is configured to provide cell balancing by reducing a voltage supplied to a battery cell of the battery module.

3. The battery module of claim 1, wherein:
the operating condition is a temperature exceeding an upper temperature threshold; and
the control operation comprises a termination of a power supply connection between the battery module and the electric aircraft.

4. The battery module of claim 1, further comprising a sensor configured to:
detect a condition parameter of the battery module; and
generate the measurement datum as a function of the condition parameter.

5. The battery module of claim 4, wherein the sensor comprises a sensor array.

6. The battery module of claim 4, wherein the sensor comprises a voltmeter configured to detect a voltage parameter of the battery module,
where the condition parameter comprises a voltage parameter.

7. The battery module of claim 4, wherein the sensor comprises a temperature sensor configured to detect a condition parameter, where the condition parameter comprises a temperature parameter.

8. The battery module of claim 7, wherein the temperature sensor comprises a thermistor.

9. The battery module of claim 7, wherein the circuit control circuit is configured to:
receive the measurement datum from the temperature sensor;
generate the condition datum, which is a function of the temperature parameter of the temperature sensor; and
perform load-sharing of the battery cell as a function of the condition datum.

10. The battery module of claim 7, wherein detecting the temperature parameter of a battery module comprises detecting a temperature of a battery cell of the battery module.

11. The battery module of claim 7, wherein detecting the temperature parameter of a battery module comprises detecting a temperature of a terminal of the battery module.

12. The battery module of claim 7, wherein detecting a temperature parameter of a battery module comprises detecting a resistance of a battery cell of the battery module.

13. The battery module of claim 1, wherein the control circuit is further configured to transmit the control signal to a pack monitoring unit (PMU), where the PMU is configured to perform the control operation.

14. The battery module of claim 13, wherein the PMU comprises a memory component configured to store the measurement datum.

15. The battery module of claim 1, wherein the plurality of MMUs are physically isolated from each other for redundancy.

16. The battery module of claim 1, wherein sensor comprises a gas vent sensor that detects byproducts of cell failure.

17. A method of battery pack management using a module monitor unit (MMU), the method comprising:
receiving, by a control circuit, a measurement datum of a battery module from a sensor communicatively connected to an MMU, wherein the battery module comprises a battery cell;
determining, by a control circuit, an operating condition of the battery module as a function of the measurement datum; and
generating, by a control circuit, a control signal to provide control operation of the battery module as a function of the operating condition, wherein the MMU comprises a plurality of MMUs, wherein the plurality of MMUs is configured to monitor the battery cell.

18. The method of claim 17, wherein:
the operating condition is a temperature exceeding an upper temperature threshold; and
the control operation comprises a termination of a power supply connection between the battery module and the electric aircraft.

19. The method of claim 17, further comprising:
detecting, by a sensor, a condition parameter of the battery module; and
generating, by a sensor, the measurement datum as a function of the condition parameter.

20. The method of claim 19, wherein the sensor comprises a temperature sensor configured to detect a condition parameter, where the condition parameter comprises a temperature parameter.
